(19) United States
(12) Patent Application Publication
(10) Pub. No.: US 2023/0260331 A1
(43) Pub. Date: Aug. 17, 2023

(54) INSTRUMENT PANEL DETERIORATION NOTIFICATION SYSTEM

(71) Applicant: TOYOTA JIDOSHA KABUSHIKI KAISHA, Toyota-shi (JP)

(72) Inventor: Yasunori NOSAKA, Toyota-shi (JP)

(73) Assignee: TOYOTA JIDOSHA KABUSHIKI KAISHA, Toyota-shi (JP)

(21) Appl. No.: 18/074,875

(22) Filed: Dec. 5, 2022

(30) Foreign Application Priority Data
Feb. 16, 2022 (JP) 2022-022295

(51) Int. Cl. G07C 5/00; G07C 5/10

(52) U.S. Cl. CPC G07C 5/006; G07C 5/10

(57) ABSTRACT

The deterioration notification system includes a history storage unit that stores respective histories of the amount of solar radiation to the vehicle and the outside air temperature of the vehicle, an arithmetic processing unit that performs deterioration determination of the instrument panel based on the respective histories of the amount of solar radiation and the outside air temperature, and a notification unit that notifies the user of the replacement of the instrument panel. The arithmetic processing unit includes an estimation unit that estimates a temperature history of the instrument panel based on each history of the solar radiation amount and the outside air temperature, a calculation unit that calculates a total heat load amount received by the instrument panel based on the temperature history, and a determination unit that determines whether or not the instrument panel is deteriorated based on the total heat load amount.

### CROSS-REFERENCE TO RELATED APPLICATION

This application claims priority to Japanese Patent Application No. 2022-022295 filed on Feb. 16, 2022, incorporated herein by reference in its entirety.

### BACKGROUND

### 1. Technical Field

The present disclosure relates to an instrument panel deterioration notification system.

### 2. Description of Related Art

An airbag that deploys in an occupant compartment is provided in front of a passenger seat of a vehicle. This type of airbag is covered by an instrument panel. The instrument panel is required to have a performance capable of efficiently breaking at the time of airbag deployment, having low deterioration, and securing a predetermined strength at a time other than the time of airbag deployment. As an instrument panel having such a performance, for example, an instrument panel disclosed in Japanese Unexamined Patent Application Publication No. 10-251414 (JP 10-251414 A) is known.

JP 10-251414 A discloses an instrument panel formed using a powder slush material for an instrument panel skin, characterized in that a periphery of a powder center portion is coated with a thermoplastic polyurethane elastomer, and that the center portion is formed of a material different from the thermoplastic polyurethane elastomer.

### SUMMARY

When the vehicle is used for a long period of time, a plasticizer contained in the material of the instrument panel is reduced due to the influence of an operating environment, such as the influence of heat or light. When the plasticizer is reduced, the instrument panel gradually becomes hard and brittle and deteriorates, and the above-described performance deteriorates. When the deterioration of the instrument panel proceeds, not only the tactile feel and the design property are impaired, but also the safety of the occupant may be impaired.

When an instrument panel is formed by selecting a material that is hardly deteriorated as much as possible, such as the instrument panel disclosed in JP 10-251414 A, there is a possibility that the instrument panel has excessive quality. If the deterioration of the instrument panel can be grasped and the instrument panel can be replaced in a timely manner, excessive quality can be avoided.

However, the deterioration state of the instrument panel greatly differs for each vehicle over a long period of time in accordance with the difference in the usage environment. Furthermore, it is not possible to cut a test piece from an instrument panel of an already sold vehicle to perform an accelerated deterioration test. Therefore, it is not easy to notify the user of the replacement of the degraded instrument panel in a timely manner.

The present disclosure provides an instrument panel deterioration notification system capable of notifying a user of a replacement of a deteriorated instrument panel in a timely manner.

An instrument panel deterioration notification system according to the present disclosure is a system that notifies a user of deterioration of an instrument panel covering an airbag that deploys in an occupant compartment of a vehicle, the system including: a history storage unit that stores respective histories of a solar radiation amount to the vehicle and an outside air temperature of the vehicle; an arithmetic processing unit that performs deterioration determination of the instrument panel based on the respective histories of the solar radiation amount and the outside air temperature; and a notification unit that notifies the user of a replacement of the instrument panel when the arithmetic processing unit determines that the instrument panel is deteriorated, in which the arithmetic processing unit includes: an estimation unit that estimates a temperature history of the instrument panel based on the respective histories of the solar radiation amount and the outside air temperature; a calculation unit that calculates a total heat load amount received by the instrument panel based on the temperature history; and a determination unit that determines whether the instrument panel is deteriorated based on the total heat load amount.

With such a configuration, the deterioration notification system can easily grasp a deterioration state of the instrument panel that is different for each vehicle. Thus, the deterioration notification system can notify the user of the replacement of the instrument panel in accordance with the deterioration state of the instrument panel. Therefore, the deterioration notification system can notify the user of the replacement of the degraded instrument panel in a timely manner while suppressing excessive quality of the instrument panel.

In the instrument panel deterioration notification system according to the present disclosure, the vehicle includes: the history storage unit; a solar radiation sensor that measures the solar radiation amount; an outside air temperature sensor that measures the outside air temperature; a position information acquiring unit that acquires position information of the vehicle; a weather information acquiring unit that acquires weather information including the solar radiation amount and the outside air temperature from outside in accordance with the position information; and a navigation device including the notification unit. The history storage unit is configured to store the measured solar radiation amount and the measured outside air temperature as the respective histories in a period in which a power source of the vehicle is started and the vehicle is in a travelable state, and store the solar radiation amount and the outside air temperature included in the acquired weather information as the respective histories in a period in which the power source is stopped and the vehicle is in a traveling stop state.

According to this aspect, in a period in which the power source of the vehicle is stopped and the vehicle is in the traveling stop state, although the vehicle stops acquiring the position information of the vehicle and the weather information and stops measuring the solar radiation and the outside air temperature, it is possible to acquire the solar radiation amount received by the vehicle and the outside air temperature in the period. Accordingly, the vehicle can store the respective histories of the solar radiation amount and the outside air temperature in which the use history of the vehicle is taken into consideration, without consuming the battery power and without losing the solar radiation amount received by the vehicle and the outside air temperature in the period in which the power source is stopped and the vehicle is in the traveling stop state. Thus, even if a special measure such as increasing the battery capacity of the vehicle is not taken for the vehicle, the deterioration notification system can accurately calculate the total heat load amount received by the instrument panel by using the device mounted on the existing vehicle. The deterioration notification system can accurately and easily grasp the deterioration state of the instrument panel different for each vehicle. Therefore, the deterioration notification system notifies the user of the replacement of the deteriorated instrument panel in a timely and easy manner while suppressing excessive quality of the instrument panel.

In the instrument panel deterioration notification system according to the present disclosure, the arithmetic processing unit further includes a prediction unit that predicts a remaining life of the instrument panel based on the total heat load amount, and the notification unit notifies the user of the predicted remaining life when the arithmetic processing unit determines that the instrument panel is not deteriorated.

According to this aspect, the deterioration notification system can not only notify the user of the replacement of the deteriorated instrument panel in a timely manner while suppressing the excessive quality of the instrument panel, but also notify the user of the replacement time of the instrument panel that is not deteriorated.

In the instrument panel deterioration notification system according to the present disclosure, when the total heat load amount is equal to or more than a threshold value set in advance for each of the materials of the instrument panel, the determination unit determines that the instrument panel is deteriorated, the prediction unit calculates a representative value of a time distribution of a temperature of the instrument panel from the temperature history, and predicts the remaining life based on the representative value, the total heat load, and the threshold value.

According to such an aspect, the prediction unit can predict the remaining life of the instrument panel based on the total heat load amount and the representative value calculated from the temperature history of the instrument panel in which the usage history of the vehicle is taken into consideration. Thus, the deterioration notification system can accurately and easily grasp the deterioration state of the instrument panel different for each vehicle without using a complicated algorithm. Thus, the deterioration notification system can accurately and easily predict the remaining life of the instrument panel. Therefore, the deterioration notification system can notify the user of the replacement of the deteriorated instrument panel in a timely and easy manner while suppressing the excessive quality of the instrument panel, and can accurately and easily notify the user of the replacement time of the instrument panel that is not deteriorated.

According to the present disclosure, it is possible to provide an instrument panel deterioration notification system capable of notifying a user of a replacement of a deteriorated instrument panel in a timely manner.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of a deterioration notification system according to the present embodiment;

FIG. 2 is a schematic view of an instrument panel viewed from an occupant compartment of a vehicle;

FIG. 3 shows the instrument panel viewed from the side;

FIG. 4 is a diagram illustrating a mounting position of an outside air temperature sensor;

FIG. 5 is a diagram illustrating information stored in a history storage unit;

FIG. 6 is a diagram showing a relationship between the temperature of the instrument panel, the amount of solar radiation, and the outside air temperature;

FIG. 7 is a diagram illustrating information stored in an information storage device; and

FIG. 8 is a flowchart illustrating an outline of an operation of the deterioration notification system.

### DETAILED DESCRIPTION OF EMBODIMENTS

Hereinafter, embodiments of the present disclosure will be described with reference to the drawings. Unless otherwise specified, the same reference numerals are assigned to the same components in the respective embodiments, and the description thereof will be omitted.

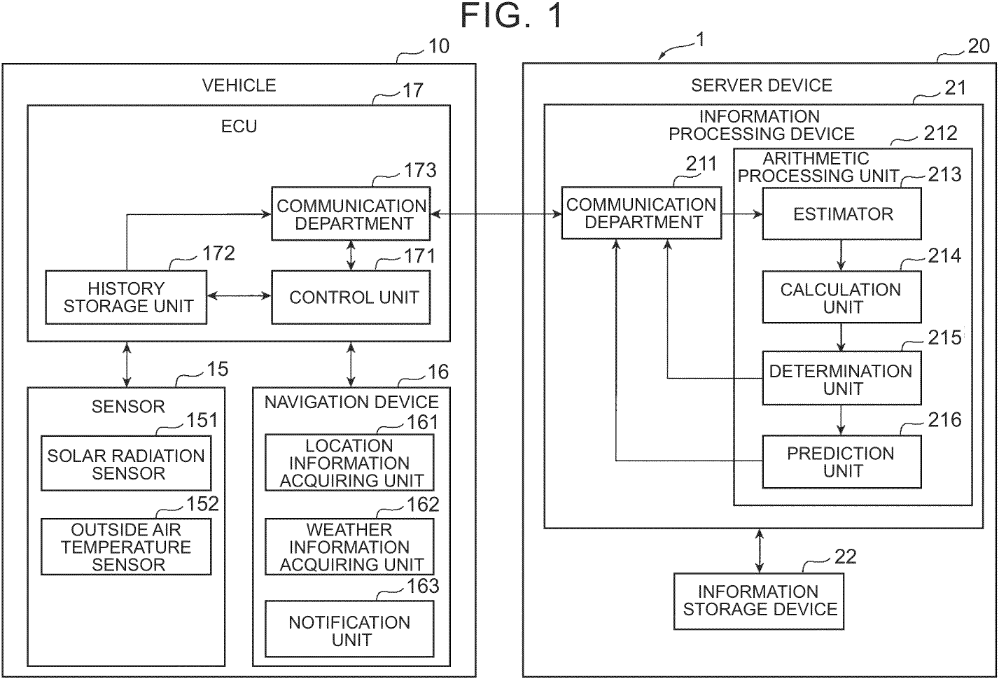

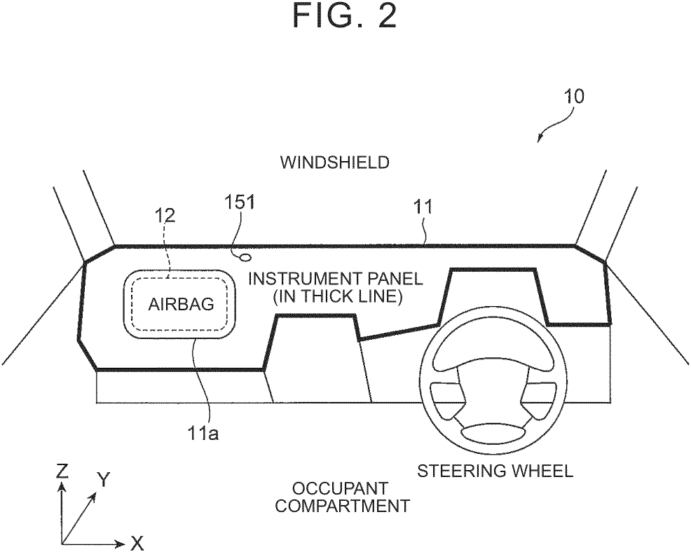

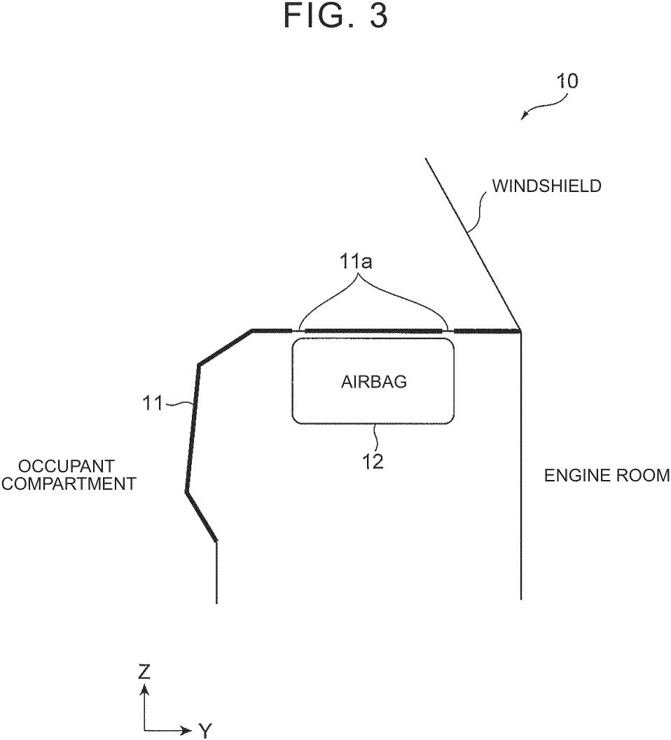

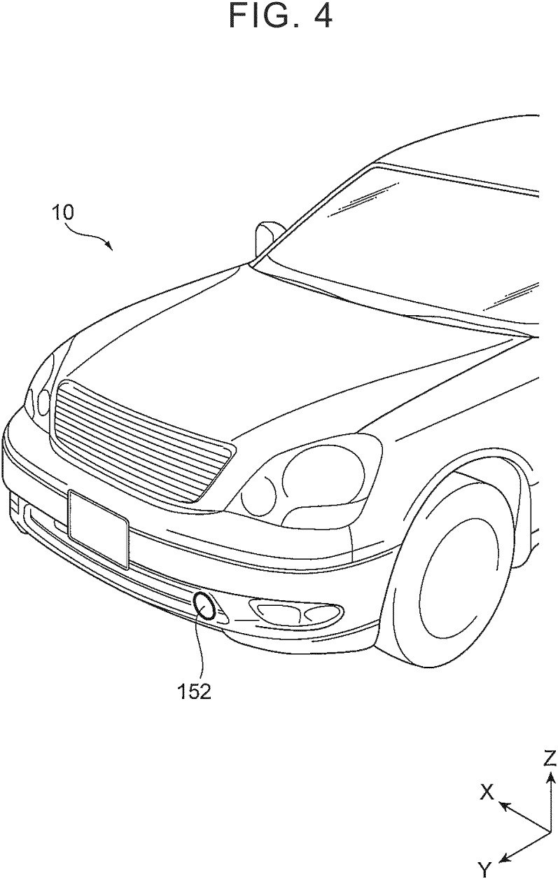

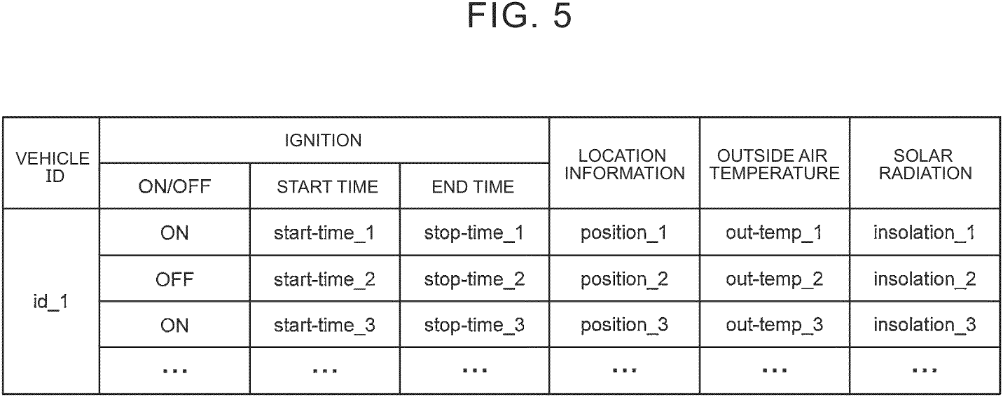

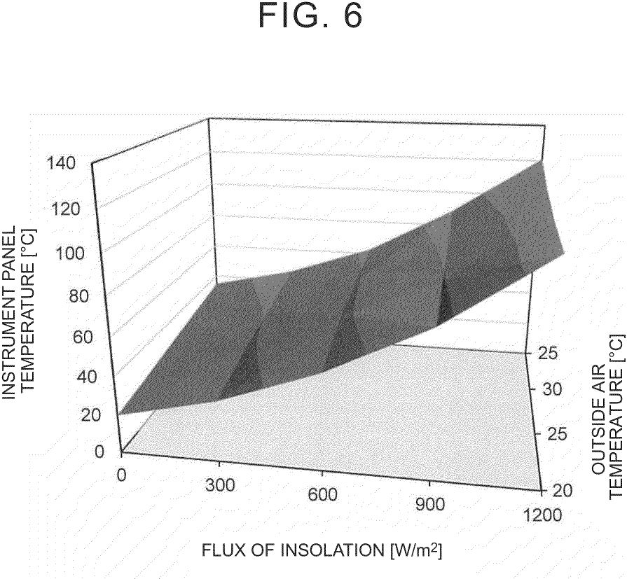

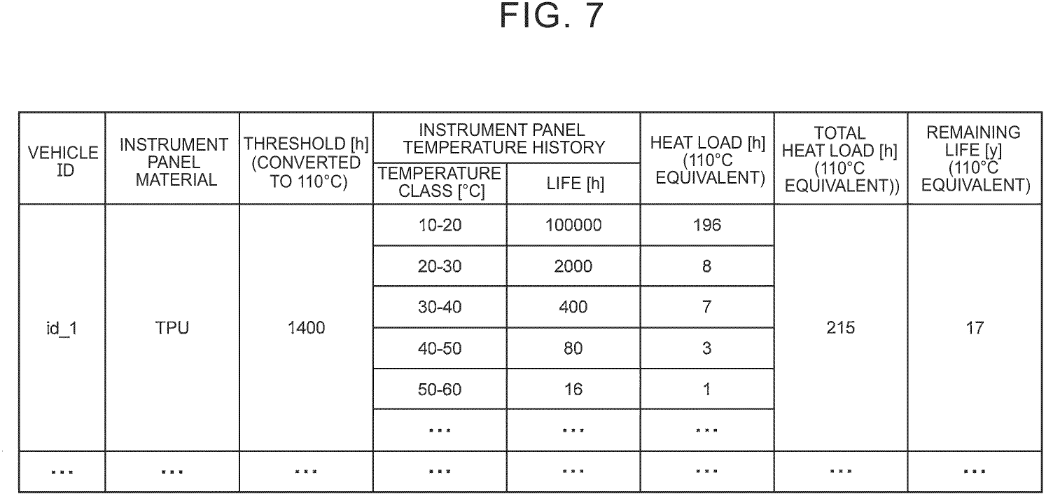

FIG. 1 is a diagram illustrating a configuration of a deterioration notification system 1 according to the present embodiment. FIG. 2 is a schematic view of the instrument panel 11 viewed from the occupant compartment of the vehicle 10. FIG. 3 is a side view of the instrument panel 11. FIG. 4 is a diagram for explaining a mounting position of the outside air temperature sensor 152. FIG. 5 is a diagram illustrating information stored in the history storage unit 172. FIG. 6 is a diagram illustrating a relationship between the temperature of the instrument panel 11, the amount of solar radiation, and the outside air temperature. FIG. 7 is a diagram illustrating information stored in the information storage device 22.

The deterioration notification system 1 is a system that notifies a user, such as a driver, of deterioration of the instrument panel 11 provided in the occupant compartment of the vehicle 10. As shown in FIG. 2, the instrument panel 11 is provided so as to extend in the left-right direction in front of the driver’s seat and the passenger’s seat. The instrument panel 11 is a panel surrounding an instrument disposed in the vicinity of the steering wheel. The instrument panel 11 is also referred to as a dashboard.

As shown in FIGS. 2 and 3, the instrument panel 11 covers an airbag 12 provided in front of a passenger seat. The airbag 12 is deployed in the occupant compartment when the vehicle 10 collides, and protects a user who rides on the passenger seat. The instrument panel 11 has a fracture portion 11a that breaks when the airbag 12 is deployed. The fracture portion 11a is constituted by, for example, a seam or the like which is fractured by an inflation pressure at the time of deployment of the airbag 12.

The material of the instrument panel 11 is mainly a thermoplastic resin material and includes a plasticizer. Examples of the material of the instrument panel 11 include thermoplastic polyurethane (TPU), polyamide nylon 66 (PA66), polypropylene (PP), and polyvinyl chloride (PVC). The material of the instrument panel 11 may be a resin material according to Arrhenius’s law at 10° C. twice.

As illustrated in FIG. 1, the deterioration notification system 1 includes a vehicle 10 provided with an instrument panel 11, and a server device 20 connected to the vehicle 10 so as to be capable of wireless communication.

The vehicle 10 includes a sensor 15 that measures a usage environment of the vehicle 10, a navigation device 16 that acquires position information and the like of the vehicle 10, and an Electronic control unit (ECUs) 17 that stores a history of information transmitted from the sensor 15 and the navigation device 16.

The sensor 15 includes a solar radiation sensor 151 that measures the amount of solar radiation to the vehicle 10, and an outside air temperature sensor 152 that measures the outside air temperature of the vehicle 10. As shown in FIG. 2, the solar radiation sensor 151 is mounted in the vicinity of a boundary portion between the instrument panel 11 and the windshield in the occupant compartment. As illustrated in FIG. 4, the outside air temperature sensor 152 is attached to a front portion of the vehicle 10, for example, in the vicinity of a front bumper. The solar radiation sensor 151 and the outside air temperature sensor 152 measure the amount of solar radiation and the outside air temperature, respectively, and transmit them to ECU 17.

The navigation device 16 includes a position information acquiring unit 161 that acquires position information of the vehicle 10, a weather information acquiring unit 162 that acquires weather information, and a notification unit 163 that notifies a user of various kinds of information. The position information acquiring unit 161 includes a GNSS receiver and the like. The weather information acquiring unit 162 acquires weather information according to the position information of the vehicle 10 from an external distribution server or the like of the vehicle 10. The external distribution server distributes weather information including the amount of solar radiation and the outside air temperature. The position information acquiring unit 161 and the weather information acquiring unit 162 acquire the position information of the vehicle 10 and the weather information corresponding to the position information. The position information acquiring unit 161 and the weather information acquiring unit 162 transmit weather information corresponding to the acquired position information and position information of the vehicle 10 to ECU 17. The notification unit 163 includes a display, a speaker, and the like. The notification unit 163 notifies the user of the information transmitted from the server device 20. In particular, when the server device 20 determines that the instrument panel 11 is deteriorated, the notification unit 163 notifies the user of the replacement of the instrument panel 11.

ECU 17 includes a control unit 171, a history storage unit 172, and a communication unit 173 that communicates with the server device 20. The control unit 171 controls each operation of the sensor 15 and the navigation device 16. The history storage unit 172 stores information transmitted from the sensor 15 and the navigation device 16.

The control unit 171 controls each operation of the sensor 15 and the navigation device 16. The control unit 171 stores information transmitted from the sensor 15 and the navigation device 16 to ECU 17 in the history storage unit 172. The control unit 171 causes the notification unit 163 of the navigation device 16 to notify the information transmitted from the server device 20. The control unit 171 includes a CPU, a ROM, a RAM, and the like, and the control unit 171 realizes the functions of the control unit 171 when the CPU executes a program stored in the ROM.

The history storage unit 172 is configured by a storage device, and stores respective histories of the amount of solar radiation to the vehicle 10 and the outside air temperature of the vehicle 10. The history of the amount of solar radiation is log data obtained by periodically recording the amount of solar radiation received by the vehicle 10 in a period from a point in time when the amount of solar radiation is traced back to a predetermined period in the past to the present (hereinafter, also referred to as a “predetermined recording period”). The history of the outside air temperature is log data obtained by periodically recording the outside air temperature of the vehicle 10 in a predetermined recording period.

Further, the history storage unit 172 stores a usage history of the vehicle 10. The usage history of the vehicle 10 includes a history of position information of the vehicle 10. Further, the usage history of the vehicle 10 includes a history of a period (hereinafter, also referred to as a “ignition ON/OFF history”) in which a power source (an engine and/or a motor, etc.) of the vehicle 10 is started and the vehicle 10 is in a travelable state (hereinafter, also referred to as a “ignition ON period”) and a period (hereinafter, also referred to as a “ignition OFF period”) in which a power source (an engine and/or a motor, etc.) of the vehicle 10 is stopped and the vehicle 10 is. The history of the position information of the vehicle 10 is log data obtained by periodically recording the position information of the vehicle 10 in a predetermined recording period. The history of the ignition ON/OFF is log data in which the starting time and the ending time of the ignition-ON period and the ignition-OFF period, respectively, are recorded in a predetermined recording period. Then, the history storage unit 172 stores the histories of the solar radiation amount and the outside air temperature in association with the use history of the vehicle 10.

The start time of the ignition OFF period may be the same as the end time of the ignition ON period immediately before the ignition OFF period. The end time of the ignition OFF period may be the same as the start time of the ignition ON period immediately after the ignition OFF period. Further, the position information of the vehicle 10 in the ignition OFF period may be the same as the position information at the time closest to the end time of the ignition ON period immediately before the ignition OFF period. That is, in the ignition OFF period, the position information acquiring unit 161 can stop the acquisition of the position information of the vehicle 10.

Further, as each history of the solar radiation amount and the outside air temperature in the period of the ignition ON, the history storage unit 172 stores the solar radiation amount and the outside air temperature measured by the solar radiation sensor 151 and the outside air temperature sensor 152, respectively, in association with the respective measurement times. As each history of the solar radiation amount and the outside air temperature during the ignition OFF period, the history storage unit 172 stores the solar radiation amount and the outside air temperature included in the weather information acquired by the weather information acquiring unit 162 in association with the acquisition time of the weather information.

The weather information acquiring unit 162 can acquire the weather information in the ignition OFF period as follows. That is, when the ignition ON period starts, the weather information acquiring unit 162 specifies the ignition OFF period immediately before the period and specifies the position information corresponding to the specified ignition OFF period. Then, the weather information acquiring unit 162 may acquire the weather information corresponding to the specified period and position information from the external distribution server. That is, in the ignition OFF period, the weather information acquiring unit 162 can stop the acquisition of the weather information. In the ignition OFF period, the solar radiation sensor 151 and the outside air temperature sensor 152 can stop the measurement of the solar radiation amount and the outside air temperature, respectively.

As described above, in the ignition OFF period, the acquisition of the position information and the weather information of the vehicle 10 and the measurement of the solar radiation amount and the outside air temperature are stopped, but the vehicle 10 can acquire the solar radiation amount and the outside air temperature received by the vehicle 10 in the period. Accordingly, the vehicle 10 can store the respective histories of the solar radiation amount and the outside air temperature in which the use history of the vehicle 10 is taken into consideration without consuming the battery power. That is, the vehicle 10 can store the amount of solar radiation and the outside air temperature received by the vehicle 10 during the ignition OFF period without being lost. Therefore, even if special measures such as increasing the battery capacity of the vehicle 10 are not taken for the vehicle 10, the deterioration notification system 1 can accurately calculate the total heat load amount received by the instrument panel 11 using the device mounted on the existing vehicle 10. The deterioration notification system 1 can accurately and easily grasp the deterioration state of the instrument panel 11 that is different for each vehicle 10. Therefore, the deterioration notification system 1 notifies the user of replacement of the deteriorated instrument panel 11 in a timely and easy manner while avoiding excessive quality of the instrument panel 11.

The history storage unit 172 may store the solar radiation amount and the outside air temperature measured by the solar radiation sensor 151 and the outside air temperature sensor 152 in association with the respective measurement times as the respective histories of the solar radiation amount and the outside air temperature in the ignition OFF period.

The communication unit 173 transmits each history (including the measurement time or the acquisition time) of the solar radiation amount and the outside air temperature stored in the history storage unit 172 as illustrated in FIG. 5 to the server device 20 in association with the vehicle ID which is the identification information of the vehicle 10. The communication unit 173 receives the information transmitted from the server device 20 and transmits the information to the notification unit 163 of the navigation device 16.

The server device 20 includes an information processing device 21 that processes information transmitted from the vehicle 10, and an information storage device 22 that stores information related to the processing of the information processing device 21.

The information processing device 21 includes a communication unit 211 that performs communication with the vehicle 10, and an arithmetic processing unit 212 that performs deterioration determination of the instrument panel 11 based on histories of the solar radiation amount and the outside air temperature transmitted from the vehicle 10. The arithmetic processing unit 212 includes an estimation unit 213, a calculation unit 214, a determination unit 215, and a prediction unit 216.

The communication unit 211 receives each history of the solar radiation amount and the outside air temperature transmitted from the vehicle 10, and transmits the history to the arithmetic processing unit 212. The communication unit 211 transmits, to the vehicle 10, a result of the deterioration determination of the instrument panel 11 and the like.

The estimation unit 213 estimates the temperature history of the instrument panel 11 based on the respective histories of the solar radiation amount and the outside air temperature transmitted from the vehicle 10. As shown in FIG. 6, the temperature of the instrument panel 11 (hereinafter, also referred to as “instrument panel temperature”) increases as the amount of solar radiation increases or the outside air temperature increases. The estimation unit 213 applies each amount of solar radiation and each outside air temperature transmitted from the vehicle 10 to a relational expression describing a relationship between the temperature of the instrument panel 11, the amount of solar radiation, and the outside air temperature. Thus, the estimation unit 213 can estimate the temperature of the instrument panel 11 corresponding to each solar radiation amount and each outside air temperature transmitted from the vehicle 10. This relational expression is derived in advance by an experiment, a simulation, or the like, and is set in advance in the estimation unit 213.

Then, the estimation unit 213 can estimate the temperature history of the instrument panel 11 using the measurement time or the acquisition time associated with the solar radiation amount and the outside air temperature transmitted from the vehicle 10. The temperature history of the instrument panel 11 may be a graph showing the time distribution of the temperature of the instrument panel 11, or may be a table showing the time distribution of the temperature of the instrument panel 11 as shown in FIG. 7. The table shown in FIG. 7 is created by aggregating the time (hereinafter, also referred to as “appearance time”) at which the temperature of the instrument panel 11 appears in each predetermined temperature class.

The calculation unit 214 calculates the total heat load amount received by the instrument panel 11 based on the temperature history of the instrument panel 11 estimated by the estimation unit 213. The total heat load amount is obtained by quantifying the degree of heat load applied to the instrument panel 11 from the time when the instrument panel 11 is mounted on the vehicle 10 to the present time. The total heat load amount may be, for example, a cumulative value of the amount of heat received by the instrument panel 11 over time, or a value obtained by converting the cumulative value into time, and the index thereof is not particularly limited.

Specifically, first, the calculation unit 214 converts the appearance time for each temperature class illustrated in FIG. 7 into a time when the temperature of the instrument panel 11 is set as the reference temperature (110° C. in FIG. 7). The calculation unit 214 sets the converted time as a heat load amount for each temperature class. At this time, the calculation unit 214 may convert the appearance time for each temperature class into the time when the upper limit value of the width of each temperature class is set as the reference temperature by using the 10° C. double rule. In the example of FIG. 7, the appearance time for a temperature class of 20° C. to 30° C. is 2000 hours. The upper limit of the temperature range of 20° C.-30° C. is 30° C. The difference between the upper limit value of 30° C. and the reference temperature of 110° C. is 80° C. Therefore, using the 10° C. 2 multiplication law, the appearance time of 2,000 hours is converted to 2000/ (2⁸) ≒ 8 hours. That is, in the example of FIG. 7, the heat load amount for the temperature class of 20° C. to 30° C. is calculated to be 8 hours. The heat load for the other temperature classes is also calculated.

Then, the calculation unit 214 calculates the total value of the heat load amounts for all the temperature classes as the total heat load amount received by the instrument panel 11. In the example of FIG. 7, 196+8+7+3+1=215 hours are calculated as the total heat load. The reference temperature is determined in advance in consideration of the safety margin from the maximum temperature that the instrument panel 11 can reach in the use environment of the vehicle 10 and the heat-resistant temperature of the material of the instrument panel 11.

The determination unit 215 determines whether or not the instrument panel 11 is deteriorated based on the total heat load amount calculated by the calculation unit 214. Specifically, when the total heat load calculated by the calculation unit 214 is equal to or greater than a predetermined threshold value for each material of the instrument panel 11, the determination unit 215 determines that the instrument panel 11 is deteriorated. When the total heat load amount is less than the threshold value, the determination unit 215 determines that the instrument panel 11 is not deteriorated.

The threshold value for the deterioration determination is determined in advance based on the degree of reduction of the plasticizer contained in the material of the instrument panel 11. For example, when the content of the plasticizer in the instrument panel 11 is reduced by 50% from the new one, it is assumed that fragments of the fracture portion 11a are scattered toward the user when the airbag 12 is deployed. In this case, it is assumed that the instrument panel 11 in which the content of the plasticizer is reduced by 50% from the new one is deteriorated. Then, in consideration of the safety margin, the total heat load to the instrument panel 11 required to reduce the content of the plasticizer from a new product by 40%, for example, may be determined as the threshold value of the deterioration determination.

In the example of FIG. 7, it is assumed that the material of the instrument panel 11 is TPU and the threshold value is predetermined at 1400 hours. In the example of FIG. 7, since the total heat load amount 215 hours is less than the threshold value 1400 hours, the determination unit 215 determines that the instrument panel 11 is not deteriorated. The remaining 1185 hours obtained by subtracting the total heat load of 215 hours from the threshold value of 1400 hours is a margin until the instrument panel 11 deteriorates.

When the determination unit 215 determines that the instrument panel 11 is deteriorated, the determination unit 215 transmits an exchange notification instruction instructing the user to notify the replacement of the instrument panel 11 to the vehicle 10 via the communication unit 211. The notification unit 163 of the navigation device 16 of the vehicle 10 notifies the user of the replacement of the instrument panel 11 based on the replacement notification instruction. On the other hand, when the determination unit 215 determines that the instrument panel 11 is not deteriorated, the determination unit 215 transmits the determination result to the prediction unit 216.

The prediction unit 216 predicts the remaining life of the instrument panel 11 based on the total heat load amount calculated by the calculation unit 214. Specifically, the prediction unit 216 predicts the remaining life based on the total heat load amount calculated by the calculation unit 214, the threshold value of the deterioration determination by the determination unit 215, and the representative value of the time distribution of the temperature of the instrument panel 11. The representative value of the time distribution of the temperature of the instrument panel 11 may be an average value, a median value, a mode value, or the like of the time distribution. The prediction unit 216 calculates the representative value from the temperature history estimated by the estimation unit 213. In the example of FIG. 7, it is assumed that the representative value is calculated to be 30° C. It is assumed that the instrument panel 11 is used at the representative value of 30° C. in the remaining 1185 hours obtained by subtracting the total heat load of 215 hours from the threshold value of 1400 hours. In this case, the prediction unit 216 predicts the remaining life of the instrument panel 11 as 1185×(2⁷)/24/365≈17 years using the 10° C. double rule.

The prediction unit 216 transmits the predicted remaining life of the instrument panel 11 to the vehicle 10 via the communication unit 211. The notification unit 163 of the navigation device 16 of the vehicle 10 notifies the user of the remaining life. Accordingly, the deterioration notification system 1 can notify the user of the replacement of the degraded instrument panel 11 in a timely manner, and can also notify the user of the replacement time of the instrument panel 11 that is not degraded.

As described above, the prediction unit 216 can predict the remaining life of the instrument panel 11 based on the total heat load amount calculated by the calculation unit 214, the threshold value of the deterioration determination by the determination unit 215, and the representative value of the time distribution of the temperature of the instrument panel 11. That is, the prediction unit 216 can predict the remaining life of the instrument panel 11 based on the total heat load amount and the representative value calculated from the temperature history of the instrument panel 11 in which the use history of the vehicle 10 is taken into consideration. Thus, the deterioration notification system 1 can accurately and easily grasp the deterioration state of the instrument panel 11 different for each vehicle 10 without using a complicated algorithm. Therefore, the deterioration notification system 1 can accurately and easily predict the remaining life of the instrument panel 11. Therefore, the deterioration notification system 1 can notify the user of the replacement of the deteriorated instrument panel 11 in a timely and easy manner while avoiding the excessive quality of the instrument panel 11, and can accurately and easily notify the user of the replacement time of the instrument panel 11 that is not degraded.

The information storage device 22 is configured by a storage device such as a database. The information storage device 22 stores the threshold value of the deterioration determination for each material of the instrument panel 11. Further, as illustrated in FIG. 7, the information storage device 22 can store the vehicle ID, the material of the instrument panel 11, the temperature history, the heat load amount for the temperature class, the total heat load amount, and the remaining life in association with each other. The temperature history, the heat load amount for the temperature class, the total heat load amount, and the remaining life are updated every time the history of the solar radiation amount and the outside air temperature is transmitted from the vehicle 10.

In addition, the information storage device 22 can store the information illustrated in FIG. 7 in the plurality of vehicles 10. The information processing device 21 may predict the remaining life of the instrument panel 11 of the vehicle 10 by considering not only the information of the vehicle 10 but also the information of the other vehicle 10 having the instrument panel 11 which is the same material as the vehicle 10 and to which the total heat load amount close to the vehicle 10 is added.

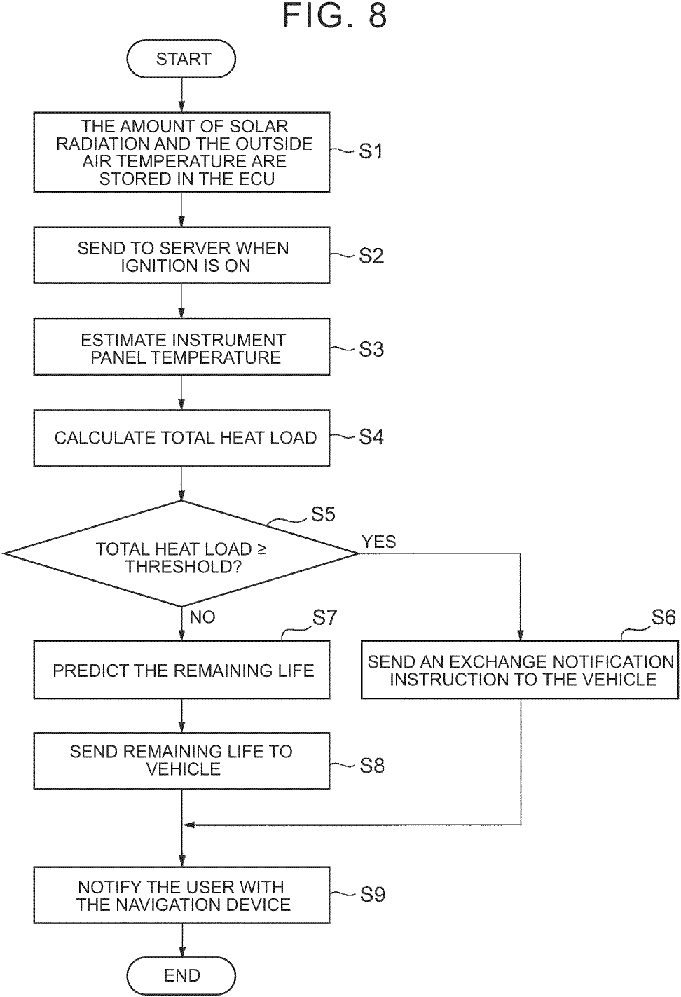

FIG. 8 is a flowchart illustrating an outline of an operation of the deterioration notification system 1.

In step S1, the deterioration notification system 1 stores the history of the amount of solar radiation to the vehicle 10 and the outside air temperature of the vehicle 10 in ECU 17.

In step S2, when the ignition of the vehicle 10 is turned on, the deterioration notification system 1 transmits the respective histories of the solar radiation amount and the outside air temperature stored in ECU 17 to the server device 20. The deterioration notification system 1 may transmit the histories stored in ECU 17 not every time the vehicles 10 are turned on, but at a frequency of once every few months, for example. When the remaining life of the instrument panel 11 reaches a predetermined value (e.g., one year remaining), the deterioration notification system 1 may change the frequency of transmitting the histories stored in ECU 17 higher than normal.

In step S3, the deterioration notification system 1 estimates the temperature of the instrument panel 11 corresponding to each solar radiation amount and each outside air temperature transmitted from the vehicle 10. Then, the deterioration notification system 1 estimates the temperature history of the instrument panel 11.

In step S4, the deterioration notification system 1 calculates the total amount of heat load received by the instrument panel 11.

In step S5, the deterioration notification system 1 determines whether or not the calculated total heat load amount is equal to or greater than a threshold value. When the calculated total heat load amount is equal to or larger than the threshold value, the deterioration notification system 1 proceeds to step S6. If the calculated total heat load is less than the threshold value, the deterioration notification system 1 proceeds to step S7.

In step S6, the deterioration notification system 1 transmits an exchange notification instruction instructing the user to notify the replacement of the instrument panel 11 to the vehicle 10. Thereafter, the deterioration notification system 1 proceeds to step S9.

In step S7, the deterioration notification system 1 predicts the remaining life of the instrument panel 11.

In step S8, the deterioration notification system 1 transmits the predicted remaining life of the instrument panel 11 to the vehicle 10.

In step S9, the deterioration notification system 1 notifies the user of the exchange notification instruction or the remaining life of the instrument panel 11 by the navigation device 16. Thereafter, the deterioration notification system 1 ends the operation illustrated in FIG. 8.

As described above, the deterioration notification system 1 of the present embodiment is a system that notifies the user of the deterioration of the instrument panel 11 covering the airbag 12 deployed in the occupant compartment of the vehicle 10. The deterioration notification system 1 includes a history storage unit 172 that stores histories of the amount of solar radiation to the vehicle 10 and the outdoor air temperature of the vehicle 10, an arithmetic processing unit 212 that performs deterioration determination of the instrument panel 11 based on the histories of the amount of solar radiation and the outdoor air temperature, and a notification unit 163 that notifies the user of the replacement of the instrument panel 11 when it is determined that the instrument panel 11 is deteriorated. The arithmetic processing unit 212 includes an estimation unit 213 that estimates a temperature history of the instrument panel 11 based on each history of the solar radiation amount and the outside air temperature, a calculation unit 214 that calculates a total heat load amount applied to the instrument panel 11 based on the temperature history, and a determination unit 215 that determines whether or not the instrument panel 11 is deteriorated based on the total heat load amount.

Thus, the deterioration notification system 1 can easily grasp the deterioration state of the instrument panel 11 that is different for each vehicle 10. Therefore, the deterioration notification system 1 can notify the user of the replacement of the instrument panel 11 according to the deterioration state of the instrument panel 11. Therefore, the deterioration notification system 1 can notify the user of replacement of the degraded instrument panel 11 in a timely manner while avoiding excessive quality of the instrument panel 11.

As a result, the deterioration notification system 1 can contribute to ensuring the tactile feel and design of the instrument panel 11 and the safety of the occupant without wasting the material of the instrument panel 11. Since the deterioration notification system 1 can improve the competitiveness of the vehicle 10 in the used vehicle market, it is possible to expand the used vehicle market and contribute to the development of a sustainable society.

Note that the hardware configuration of the deterioration notification system 1 is not limited to the configuration illustrated in FIG. 1. For example, the history storage unit 172 may be provided in the server device 20. The arithmetic processing unit 212 may be provided in the vehicle 10. The notification unit 163 may be provided in a device different from the navigation device 16, such as a mobile terminal of a user or a terminal device of a management company that manages the vehicle 10.

Although the embodiments of the present disclosure have been described in detail above, the present disclosure is not limited to the above-described embodiments. The present disclosure can be variously modified without departing from the spirit of the present disclosure described in the claims. The present disclosure can add a configuration of an embodiment to a configuration of another embodiment, replace a configuration of an embodiment with another embodiment, or delete a part of a configuration of an embodiment.

What is claimed is:

1. A system that notifies a user of deterioration of an instrument panel covering an airbag that deploys in an occupant compartment of a vehicle, the system comprising:
a history storage unit that stores respective histories of a solar radiation amount to the vehicle and an outside air temperature of the vehicle;
an arithmetic processing unit that performs deterioration determination of the instrument panel based on the respective histories of the solar radiation amount and the outside air temperature; and
a notification unit that notifies the user of a replacement of the instrument panel when the arithmetic processing unit determines that the instrument panel is deteriorated,
wherein the arithmetic processing unit includes:
an estimation unit that estimates a temperature history of the instrument panel based on the respective histories of the solar radiation amount and the outside air temperature;
a calculation unit that calculates a total heat load amount received by the instrument panel based on the temperature history; and
a determination unit that determines whether the instrument panel is deteriorated based on the total heat load amount.

2. The system according to claim 1, wherein
the vehicle includes:
the history storage unit;
a solar radiation sensor that measures the solar radiation amount;
an outside air temperature sensor that measures the outside air temperature;
a position information acquiring unit that acquires position information of the vehicle; a weather information acquiring unit that acquires weather information including the solar radiation amount and the outside air temperature from outside in accordance with the position information;
a navigation device including the notification unit; and
wherein the history storage unit is configured to
store the measured solar radiation amount and the measured outside air temperature as the respective histories in a period in which a power source of the vehicle is started and the vehicle is in a travelable state, and
store the solar radiation amount and the outside air temperature included in the acquired weather information as the respective histories in a period in which the power source is stopped and the vehicle is in a traveling stop state.

3. The system according to claim 2, wherein:
the arithmetic processing unit further includes a prediction unit that predicts a remaining life of the instrument panel based on the total heat load amount; and
the notification unit notifies the user of the predicted remaining life when the arithmetic processing unit determines that the instrument panel is not deteriorated.

4. The system according to claim 3, wherein:
when the total heat load amount is equal to or more than a threshold value set in advance for each of materials of the instrument panel, the determination unit determines that the instrument panel is deteriorated;
the prediction unit is configured to
calculate a representative value of a time distribution of a temperature of the instrument panel from the temperature history, and
predict the remaining life based on the representative value, the total heat load amount, and the threshold value.
